(19) United States
(12) Patent Application Publication
(10) Pub. No.: US 2006/0225540 A1
(43) Pub. Date: Oct. 12, 2006

(54) Adapter for impact rotary tool

(75) Inventors: Kim Y.C. Tsai, Taichung Hsien (TW); Cheng-I Teng, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/103,547

(22) Filed: Apr. 12, 2005

(51) Int. Cl. B25B 23/16; B23B 31/06

(52) U.S. Cl. 81/177.85; 81/177.2; 279/144

(57) ABSTRACT

An adapter for an electric/pneumatic impact rotary tool includes a first body and a second body. The first and second bodies are cylindrical and coaxial with each other. The first body has a square coupling hole for coupling a cuboid output end of the impact rotary tool. The second body has a screw hole and an external thread, which is located on an outer periphery of the second body and is converse in direction to a thread of the screw hole, for coupling a tool.

### BACKGROUND OF THE INVENTION

1. Field of the Invention

The present invention relates generally to electric or pneumatic impact rotary tools, and more particularly, to an adapter for connection between a tool chuck and a pneumatic/electric impact rotary tool.

2. Description of the Related Art

While a conventional electric or pneumatic impact rotary tool is operated, an adapter is required. The adapter includes a square hole and a polyangular hole, having a square opening and a polyangular opening at two opposite ends thereof respectively for inserting a square output end of the impact rotary tool and a head of a screw bolt, the square opening abutting the square hole, the polyangular opening abutting the polyangular hole. After the square output end is inserted into the square hole and the head of the screw bolt is inserted into the polyangular hole, the rotary power generated by the impact rotary tool can be transmitted to the screw bolt through the adapter.

However, since the output end of the impact rotary tool is cuboid, the impact rotary tool will not function multipurposely if it fails to fit the above-mentioned adapter. Thus, an improved adapter for such impact rotary tool is necessary for development.

### SUMMARY OF THE INVENTION

The primary objective of the present invention is to provide an improved adapter for connection between a pneumatic/electric impact rotary tool and a tool chuck to transmit a rotary power generated by the impact rotary tool to the tool chuck and to enable the tool chuck to drive a tool, like a drill bit, for rotation to enable the impact rotary tool to function multipurposely.

The foregoing objective of the present invention is attained by the improved adapter, which includes a first body and a second body, wherein the first and second bodies are cylindrical and coaxial with each other. The first body has an outer diameter that is larger than that of the second body. The first body has a first distal portion, a square coupling hole located coaxially, and a square first opening provided at the first distal portion and abutting the square coupling hole for inserting a cuboid output end of an electric/pneumatic impact rotary tool. The second body has a second distal portion, a screw hole, an external thread, and a second opening, wherein the second distal portion faces against the first distal portion, the screw hole is coaxial with the square coupling hole, the second opening is provided at the second distal portion and abuts the screw hole, and the external thread is located on an external periphery of the second body and converse in direction to a thread of the screw hole, for coupling a tool chuck.

### BRIEF DESCRIPTION OF THE DRAWINGS

FIG. 1 is a perspective view of a preferred embodiment of the present invention.

FIG. 2 is an elevation view of the preferred embodiment of the present invention.

FIGS. 3 and 4 are side views of the preferred embodiment of the present invention.

FIG. 5 is a sectional view taken from a line 5-5 indicated in FIG. 3.

FIGS. 6 and 7 are schematic views of the preferred embodiment of the present invention in cooperation with an impact rotary tool.

### DETAILED DESCRIPTION OF PREFERRED EMBODIMENTS

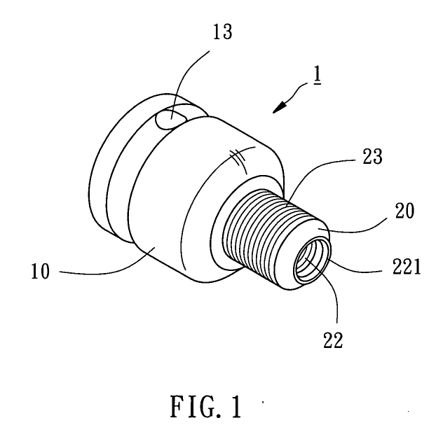

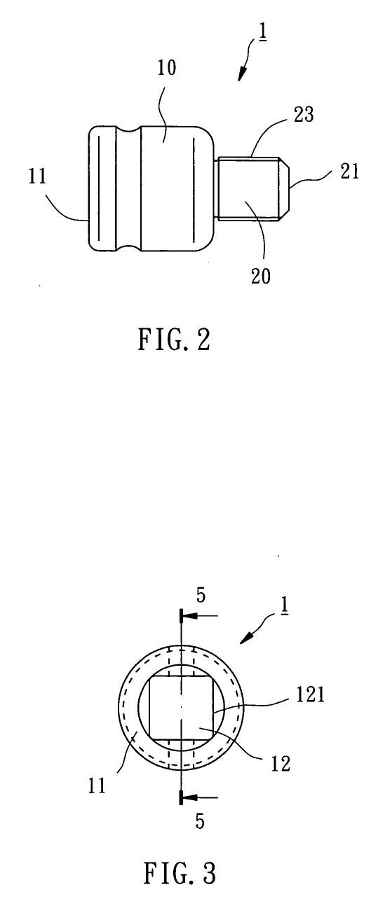

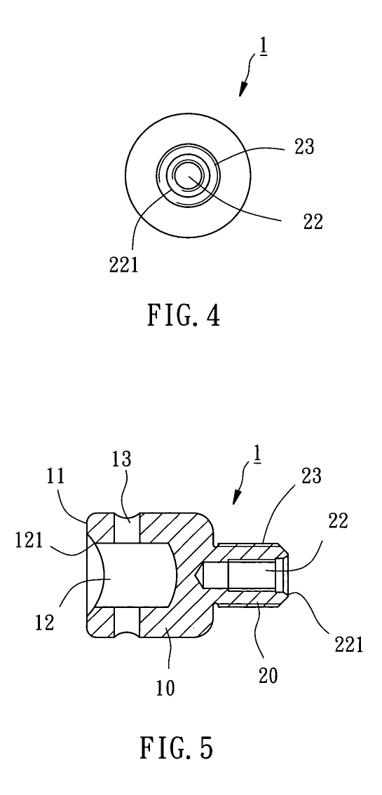

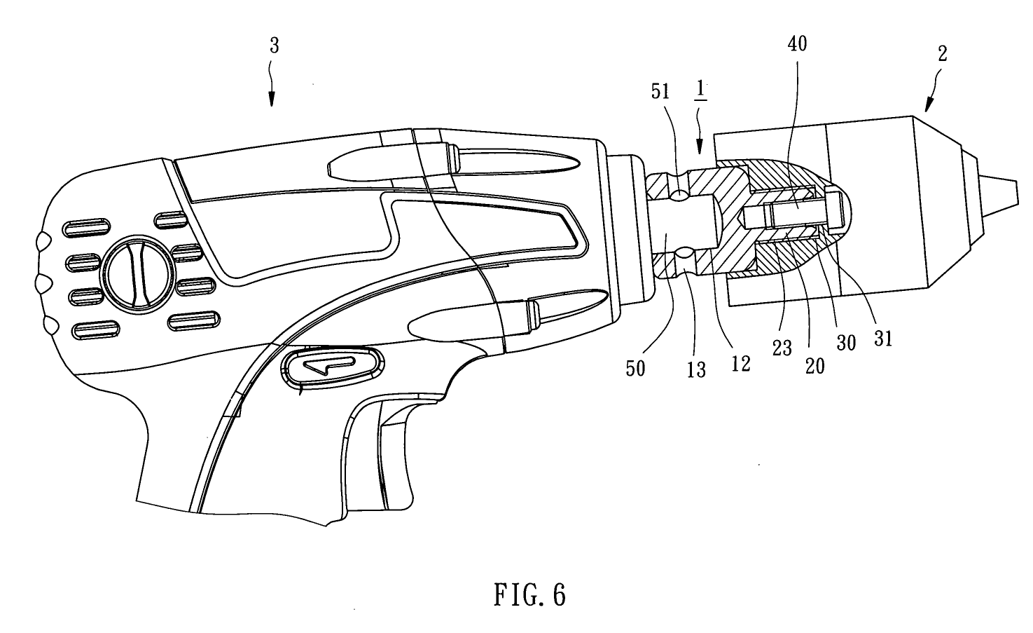

Referring to FIGS. 1-5, an adapter 1 for an electric/pneumatic impact rotary tool, constructed according to a preferred embodiment of the present invention, is composed of a first body 10 and a second body 20, wherein the first and second bodies 10 and 20 are cylindrical and coaxial with each other, and the first body 10 has a larger outer diameter than that of the second body 20. The impact rotary tool includes a cuboid output end, which has two resilient locating pins.

The first body 10 includes a first distal portion 11, a square coupling hole 12, a square first opening 121, and two locating holes 13. The coupling hole 12 is coaxial with the first body 10. The first opening 121 is located at the first distal portion 11, abutting the coupling hole 12 for coupling the cuboid output end of the impact rotary tool. The two locating holes 13 run respectively through two opposite sides of the first body 10, for communication with the coupling hole 12 and outside and inserting the resilient locating pins of the output end while the coupling hole 12 is coupled with the output end of the impact rotary tool.

The second body 20 includes a second distal portion 21, a screw hole 22, and an external thread 23, for coupling a tool chuck. The second distal portion 21 faces against the first distal portion 11. The screw hole 22 is coaxial with the coupling hole 12. A second opening 221 is provided at the second distal portion 21, abutting the screw hole 22.

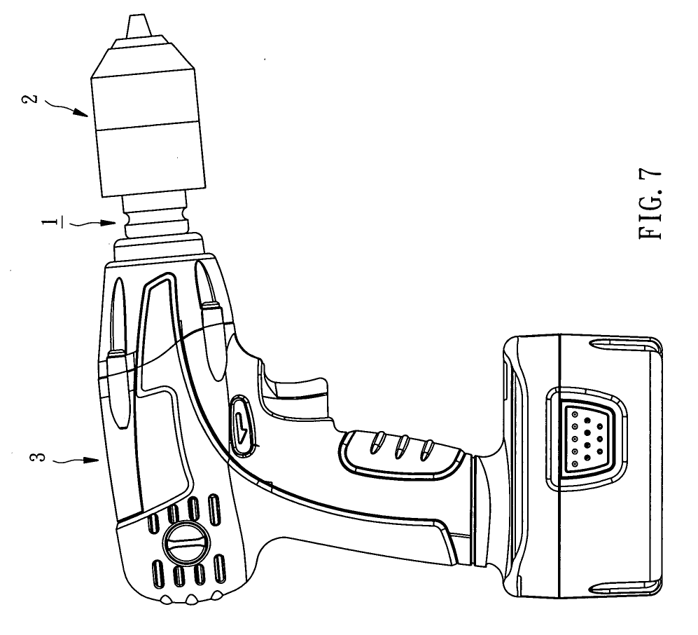

Referring to FIG. 6, the adapter 1 can fit a conventional tool chuck 2, like drill chuck, wherein the tool chuck 2 has a coupling screw hole 30 and a through hole 31. The adapter 1 is coupled with the tool chuck 2 in such a manner that the external thread 23 of the second body 20 is threadedly fitted with the coupling screw hole 30 of the tool chuck 2, and then a screw bolt 40 is inserted through a front end of the tool chuck 2 and the through hole 31 and threadedly with the screw hole 22 of the adapter 1.

Referring to FIGS. 6 and 7, after the adapter 1 and the tool chuck 2 are interconnected, the adapter 1 can be coupled with the output end 50 of the electric/pneumatic impact rotary tool 3. In other words, the coupling hole 12 of the adapter 1 is fitted onto the square output end 50 of the impact rotary tool 3 and the resilient locating pins 51 of the output end 50 are inserted respectively into the locating holes 13 of the adapter 1 to interconnect the adapter 1 and the tool chuck 2. Thus, the user can employ the tool chuck 2 to hold a tool, like drill bit, and the rotary power generated by the impact rotary tool can drive the drill bit for drilling, thereby enabling the impact rotary tool 3 to function multipurposely.

What is claimed is:

1. An adapter for an electric/pneumatic impact rotary tool, said impact rotary tool having a cuboid output end, said adapter comprising:
a first body having a first distal portion and a square coupling hole, said coupling hole being coaxial with said first body, said coupling having a square first opening at said first distal portion for inserting said coupling hole onto said cuboid output end of said impact rotary tool; and
a second body having a second distal portion, a screw hole, and an external thread, said second distal portion facing against said first distal portion, said screw hole being coaxial with said coupling hole, said screw hole having a second opening at said second distal portion, said external thread being located on an outer periphery of said second body and being converse in direction to a thread of said screw hole, whereby said second body can be coupled with a tool chuck;
both of said first and second bodies being cylindrical and located coaxially, said first body having a larger outer diameter than that of said second body.

2. The adapter as defined in claim 1, wherein said output end of said impact rotary tool comprises two resilient locating pins; said first body comprises two locating holes, said two locating holes running through two opposite sides of said first body for inserting said two resilient locating pins.
